(19) United States
(12) Patent Application Publication
(10) Pub. No.: US 2008/0268680 A1
(43) Pub. Date: Oct. 30, 2008

(54) Electronic device with a plug guard

(75) Inventors: Lien-Hsun Ho, Taipei (TW); Yuan-Liang Hsu, Taipei (TW); Tung-Yuan Chen, Taipei (TW); Chao-Yi Wu, Taipei (TW)

Correspondence Address: CHARLES E. BAXLEY, ESQUIRE, 90 JOHN STREET, SUITE 309, NEW YORK, NY, 10038, US

(73) Assignee: Cyber Power System Inc.

(21) Appl. No.: 11/789,250

(22) Filed: Apr. 24, 2007

(51) Int. Cl. H01R 13/44

(52) U.S. Cl. 439/140

(57) ABSTRACT

An electronic device with a plug guard that can be connected to an external power source and other digital source respectively by a power plug and a digital data plug and has an electronic device and a plug guard. The electronic device has an outer surface and an integrated external interface socket. The integrated external interface socket is formed in the outer surface and has a power segment and at least one digital data segment formed in-line and communicating with each other. The plug guard is mounted securely on the outer surface of the electronic device adjacent to the digital data segments to keep the power plug from being plugged into the digital data segment.

### BACKGROUND OF THE INVENTION

1. Field of the Invention

The present invention relates to an electronic device with a plug guard, and more particularly to an electronic device with an integrated socket and a plug guard to guarantee that external interface plugs are inserted into correct segments of the integrated socket formed in an electronic device.

2. Description of Related Art

As electronic devices become smaller and smaller, arrangeable space on external surfaces of the devices has become critically limited. As a result, power and data sockets have been integrated into a single interface socket and connect to a source of electricity or transmit digital data. Different sockets can be in different shapes and have different numbers of pins, prongs or holes to connect respectively with different plugs.

The sockets on an electronic device are generally mounted adjacent to each other and may be formed as a single mounting element. A person has to be attentive to how many pins, prongs or holes the sockets have and choose the correct socket. Because the sockets are often located in inconvenient positions, selecting the correct socket may be tedious and occasionally results in a plug being inserted into an incorrect socket when the user is not particularly attentive.

To overcome these shortcomings, the present invention provides an electronic device with a plug guard to obviate or mitigate the aforementioned problems.

### SUMMARY OF THE INVENTION

The main objective of the present invention is to provide an electronic device with a plug guard to guarantee that plugs are inserted into correct segments of an integrated socket formed in the electronic device.

To achieve this objective, the electronic device has an outer surface and an integrated external interface socket. The integrated external interface socket is formed on the outer surface and has a power segment and at least one digital data segment formed in-line and communicating with each other.

The plug guard is mounted securely on the outer surface of the electronic device adjacent to the digital data segment to keep a power plug from being plugged into the digital data segment.

Other objectives, advantages and novel features of the invention will become more apparent from the following detailed description when taken in conjunction with the accompanying drawings.

### BRIEF DESCRIPTION OF THE DRAWINGS

FIG. 1 is an exploded operational perspective view of an electronic device with a plug guard in accordance with the present invention and external interface plugs;

FIG. 2 is an operational perspective view of the electronic device in FIG. 1;

FIG. 3 is an operational end view of the electronic device in FIG. 1; and

FIG. 4 is another operational perspective view of the electronic device in FIG. 1.

### DETAILED DESCRIPTION OF THE PREFERRED EMBODIMENT

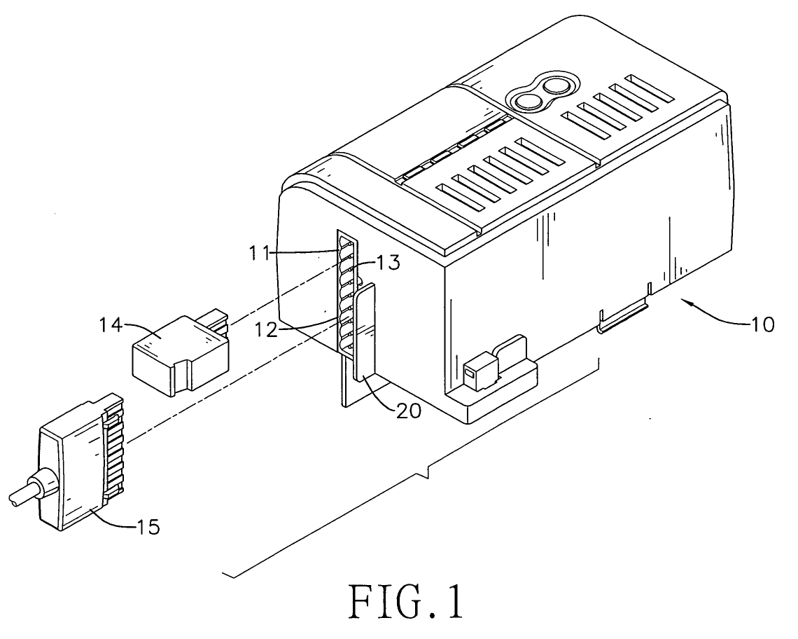

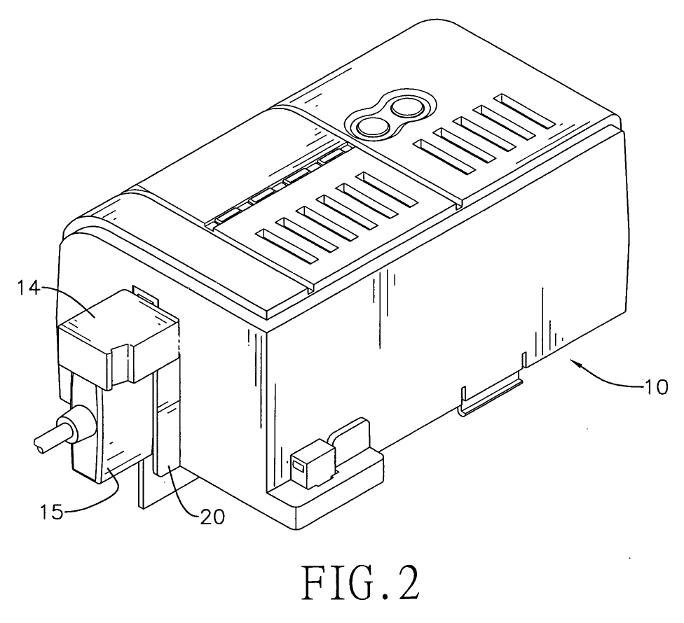

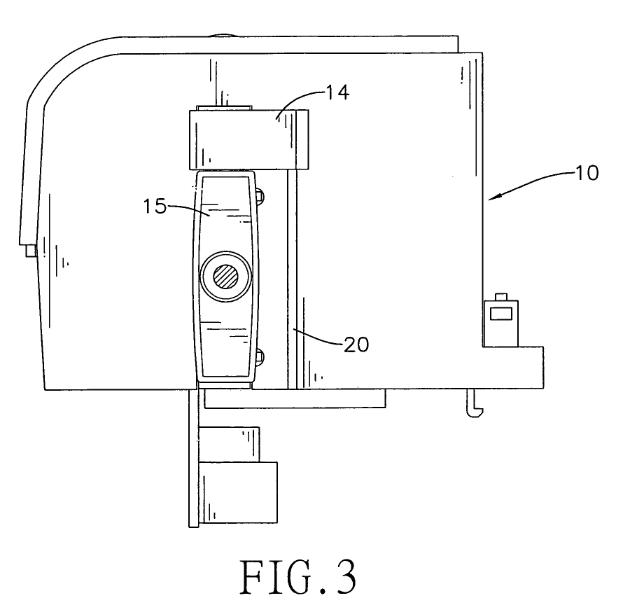

With reference to FIGS. 1, 2 and 3, an electronic device with a plug guard can be connected to an external power source and digital sources, respectively, by a power plug (14) and a digital data plug (15) and comprises an electronic device (10) and a plug guard (20).

The power plug (14) is elongated and has an end and multiple pin connectors. The pin connectors are formed transversely on and protrude from the end of the power plug (14).

The digital data plug (15) is elongated and has an end and multiple pin connectors. The pin connectors are formed longitudinally on and protrude from the end of the digital data plug (15).

The electronic device (10) has an outer surface and an integrated external interface socket. The integrated external interface socket is formed in the outer surface of the electronic device (10) and has a power segment (11) and at least one data segment (12). The power segment (11) is connected to by the power plug (14) and has a closed end, an open end, two sides and multiple pins (13)(may be two electrode pins or two electrode pins and a ground wire). The pins (13) are mounted in-line in the power segment (11) parallel to and between the two sides and make electrical connection respectively to the pin connectors in the power plug (14). The data segment (12) is connected to by the digital data plug (15), is formed in-line and communicates with the power segment (11) and has a closed end, an open end, two sides and multiple pins (13). The open end of the data segment (12) is connected to and communicates with the open end of the power segment (11). The pins (13) in the data segment (12) are mounted in the data segment (12) parallel to and between the two sides in-line with the pins (13) in the power segment (11) and make electrical connection respectively to the pin connectors in the digital data plug (15).

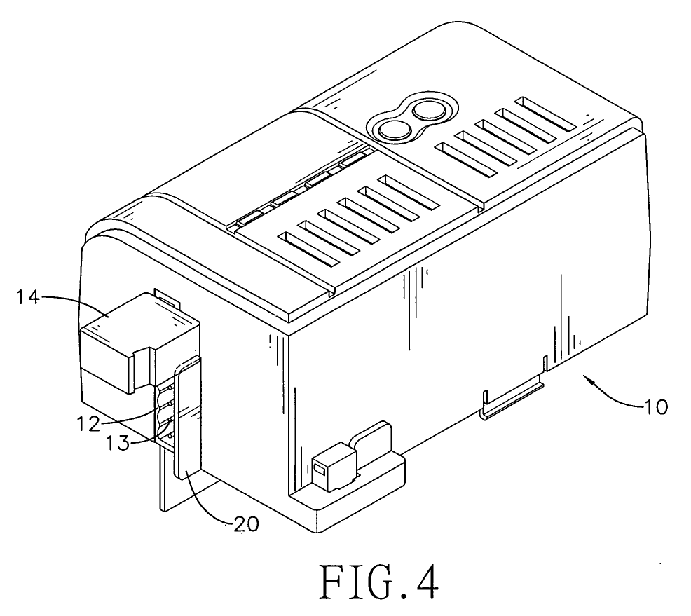

The plug guard (20) may be flat, is mounted securely on the surface of the electronic device (10) adjacent to the data segment (12) of the integrated external interface socket, is separated from the data segment (12) by a gap and has an upper end, a lower end and an outer edge. The gap is wide enough to allow the digital data plug (15) to plug into the data segment (12) of the integrated external interface socket but too narrow to allow the power plug (14) to plug into the data segment (12). With further reference to FIG. 4, the upper end of the plug guard (20) is flush with the open end of the data segment (12) of the integrated external interface socket, and the lower end of the plug guard (20) is adjacent to the closed end of the data segment (12) such that the power plug (14) can only be plugged into the power segment (11) of the integrated external interface socket.

Otherwise, the plug guard is simple, such that manufacturing of the electronic device with a plug guard in accordance with present invention is very easy and low cost.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

1. An electronic device with a plug guard comprising:
An electronic device having
a surface; and
an integrated external interface socket being formed in the surface and having
a power segment having
a closed end;
an open end;
two sides; and
two pins being mounted in-line in the power segment parallel to and between the two sides; and
at least one data segment being formed in-line and communicating with the power segment and having
a closed end;
an open end being connected to and communicating with the open end of the power segment;
two sides; and
multiple pins being mounted in the data segment parallel to and between the two sides in-line with the pins in the power segment; and
a plug guard being mounted securely on the surface of the electronic device adjacent to the data segment of the integrated external interface socket and being separated from the data segment by a gap.

2. The plug guard as claimed in claim 1, wherein the plug guard is flat.

3. (canceled)
